(19) United States
(12) Patent Application Publication
(10) Pub. No.: US 2020/0019003 A1
(43) Pub. Date: Jan. 16, 2020

(54) DISPLAY DEVICE, METHOD FOR MANUFACTURING DISPLAY DEVICE AND SEALANT

(71) Applicant: BOE TECHNOLOGY GROUP CO., LTD., Beijing (CN)

(72) Inventors: Detao ZHAO, Beijing (CN); Dongni LIU, Beijing (CN); Li XIAO, Beijing (CN); Lei WANG, Beijing (CN); Minghua XUAN, Beijing (CN); Xiaochuan CHEN, Beijing (CN)

(73) Assignee: BOE TECHNOLOGY GROUP CO., LTD., Beijing (CN)

(21) Appl. No.: 16/406,714

(22) Filed: May 8, 2019

(30) Foreign Application Priority Data
Jul. 13, 2018 (CN) 201810770516.2

(51) Int. Cl. G02F 1/1339; G02F 1/1333

(52) U.S. Cl. CPC G02F 1/1339; G02F 2001/133334; G02F 1/133308

(57) ABSTRACT

The present disclosure provides a display device, a method for manufacturing the display device and a sealant. The display device includes a first substrate, a second substrate arranged opposite to the first substrate, and the sealant configured to seal the first substrate and the second substrate. The sealant includes a colloid and a plurality of magnetic particles arranged in the colloid, and each magnetic particle includes a supporting core and a magnetic layer enclosing an outer surface of the supporting core. A magnetic field force pointing toward the first substrate or the second substrate is applied to each magnetic particle under the effect of an external magnetic field.

### CROSS-REFERENCE TO RELATED APPLICATION

This application claims priority to Chinese Patent Application No. 201810770516.2 filed on Jul. 13, 2018, which is incorporated herein by reference in its entirety.

### TECHNICAL FIELD

The present disclosure relates to the field of display technology, in particular to a display device, a method for manufacturing the display device and a sealant.

### BACKGROUND

Liquid crystal display devices have been widely used due to such advantages as being thin, low power consumption and being free of radiation. Most of the market-available liquid crystal display devices are backlight-type ones, and each backlight-type liquid crystal display device includes a liquid crystal display panel and a backlight module.

Usually, the liquid crystal display panel includes a color filter (CF) substrate, a thin film transistor (TFT) array substrate arranged opposite to the color filter substrate and adhered to the color filter substrate through a sealant, and a liquid crystal layer arranged between the color filter substrate and the array substrate.

As an indispensable material for a manufacture of the liquid crystal display panel, the sealant is adopted to firmly adhere the color filter substrate to the array substrate, and fully cover lines on the array substrate so as to prevent the lines from being corroded.

### SUMMARY

In one aspect, the present disclosure provides in some embodiments a display device, including a first substrate, a second substrate arranged opposite to the first substrate, and a sealant configured to seal the first substrate and the second substrate. The sealant includes a colloid and a plurality of magnetic particles arranged in the colloid, and each magnetic particle includes a supporting core and a magnetic layer enclosing an outer surface of the supporting core. A magnetic field force pointing toward the first substrate or the second substrate is applied to each magnetic particle under the effect of an external magnetic field.

In another aspect, the present disclosure provides in some embodiments a sealant including a colloid and a plurality of magnetic particles arranged in the colloid. Each magnetic particle includes a supporting core and a magnetic layer enclosing an outer surface of the supporting core.

In yet another aspect, the present disclosure provides in some embodiments a method for manufacturing the above-mentioned display device, including: applying a sealant onto a first substrate or a second substrate, and arranging the first substrate opposite to the second substrate to form a cell; placing the first substrate and the second substrate in an external magnetic field so as to apply a magnetic field force pointing toward the first substrate or the second substrate to each magnetic particle, and curing the sealant; and moving the first substrate and the second substrate out of the external magnetic field after the sealant has been cured.

### BRIEF DESCRIPTION OF THE DRAWINGS

The above-mentioned and other aspects as well as advantages of the present disclosure will be given or may become apparent in the following description in conjunction with the drawings, and in these drawings,

FIG. 1 is a schematic view showing a process for manufacturing a display panel in the related art;

FIG. 2 is a sectional view of a display device according to one embodiment of the present disclosure;

FIG. 3 is a planar view of the display device according to one embodiment of the present disclosure;

FIG. 4 is a schematic view showing a magnetic particle according to one embodiment of the present disclosure;

FIG. 5 is another sectional view of the display device according to one embodiment of the present disclosure;

FIG. 6 is a solid view of the display device according to one embodiment of the present disclosure;

FIG. 7 is a schematic view showing a situation where a magnetic field force is applied to the display panel at a position where a sealant is located according to one embodiment of the present disclosure; and

FIG. 8 is a flow chart of a method for manufacturing the display panel according to one embodiment of the present disclosure.

### REFERENCE SIGN LIST

1 first substrate
2 sealant
20 magnetic particle
21 supporting core
22 magnetic layer
23 insulation layer
3 liquid crystal
4 second substrate
51 magnetic field generation unit
6 conductive loop
7 electromagnetic conversion member
71 wire
72 power source
73 coil

### DETAILED DESCRIPTION

The present disclosure will be described hereinafter in conjunction with the drawings and embodiments. The following embodiments are for illustrative purposes only, but shall not be used to limit the scope of the present disclosure. An identical or similar reference numeral in the embodiments of the present disclosure represents an identical or similar element.

Unless otherwise defined, such words as “one” or “one of” are merely used to represent the existence of at least one member, rather than to limit the number thereof. Such words as “include” or “including” intend to indicate that there are the features, integers, steps, operations, elements and/or assemblies, without excluding the existence or addition of one or more other features, integers, steps, operations, elements, assemblies and/or combinations thereof. In the case that one element is connected or coupled to another element, it may be directly connected or coupled to the other element, or an intermediate element may be arranged therebetween. At this time, the element may be connected or coupled to the other element in a wireless or wired manner. In addition, the expression “and/or” is used to indicate the existence of all or any one of one or more of listed items, or combinations thereof.

Unless otherwise defined, any technical or scientific term used herein shall have the common meaning understood by a person of ordinary skills. Any term defined in a commonly-used dictionary shall be understood as having the meaning in conformity with that in the related art, shall not be interpreted idealistically and extremely.

The process for manufacturing a display panel in the related art will be described hereinafter at first.

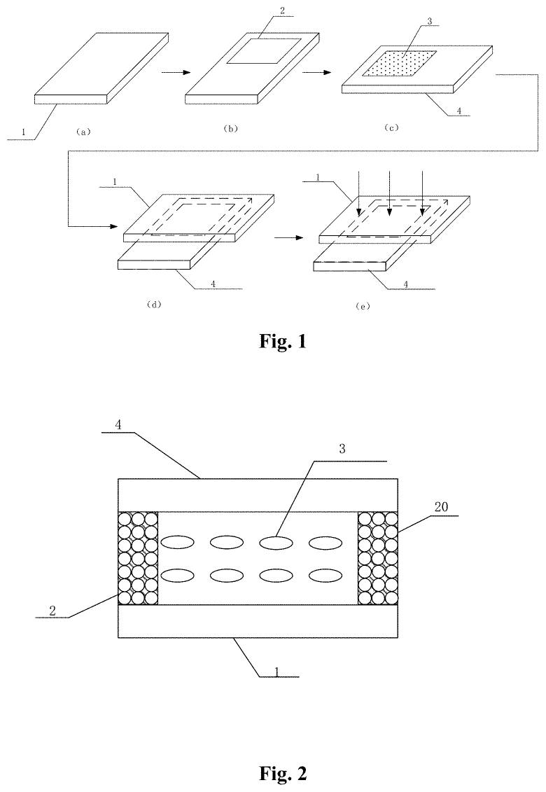

FIG. 1 shows the process for manufacturing the display panel in the related art. As shown in FIG. 1, the process for manufacturing the display panel may include the following steps.

Step (a): providing a first substrate 1. The first substrate 1 may be an array substrate or a color filter substrate.

Step (b): applying a sealant 2 to the first substrate 1 at a predetermined position. To be specific, the sealant 2 may be applied to a periphery of the first substrate 1, i.e., the sealant 2 may be applied in such a manner as to form an approximately square or rectangular shape. Of course, a shape of the sealant 2 may be selected in accordance with the practical need.

Step (c): providing a second substrate 4. When the first substrate 1 is an array substrate, the second substrate 4 may be a color filter substrate, and when the first substrate 1 is a color filter substrate, the second substrate 4 may be an array substrate. Then, liquid crystals 3 may be dripped onto the second substrate 4 in a One Drop Fill (ODF) manner.

Step (d): turning over the first substrate 1, and attaching the first substrate 1 to the second substrate 4 to form a cell. At this time, the second substrate 4 may be adhered to the first substrate 1 through the sealant 2.

Step (e): irradiating the sealant 2 with ultraviolet light after the cell formation (in a direction as indicated by arrows in FIG. 1) so as to pre-cure the sealant 2, and then thermosetting the sealant 2 to acquire the display panel.

It is found that, after the cell formation and before the pre-curing of the sealant with the ultraviolet light, such defects as the sealant being pierced through by liquid crystals, pollution of liquid crystals, and afterimages may occur, and thereby the display quality of the display panel may be adversely affected. In addition, moisture may enter the sealant, resulting in corrosion of lines on the array substrate and thereby display abnormalities.

The sealant is located adjacent to a display region, and after the cell formation, the liquid crystals in a liquid crystal layer may diffuse outwardly. When the liquid crystals are in contact with the sealant which has not been cured, the above-mentioned defects such as the sealant being pierced through by the liquid crystals, the pollution of liquid crystals, and the afterimages may occur, and thereby the display quality of the display panel may be adversely affected. In addition, moisture may enter the sealant, resulting in corrosion of wires on the array substrate and thereby display abnormalities.

In a word, in the related art, when the liquid crystals are in contact with the sealant which has not been cured, the display quality of the liquid crystal display panel may be adversely affected, and thereby the display abnormalities may occur subsequently.

An object of the present disclosure is to provide a display device, a manufacturing method thereof and a sealant, so as to solve the above-mentioned problem.

Technical solutions of the present disclosure will be described in detailed in conjunction with the drawings as follows.

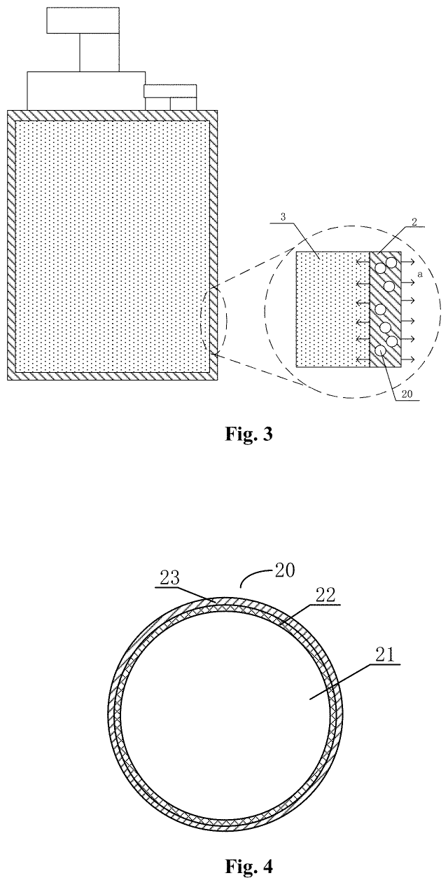

The present disclosure provides in some embodiments a display device which, as shown in FIGS. 2 and 3, includes a first substrate 1, a second substrate 4 arranged opposite to the first substrate 1, and a sealant 2 configured to seal the first substrate 1 and the second substrate 4. The sealant 3 includes a colloid and a plurality of magnetic particles 20 arranged in the colloid.

As shown in FIG. 4, each magnetic particle 20 may include a supporting core 21 and a magnetic layer 22 enclosing an outer surface of the supporting core 21. A magnetic field force pointing toward the first substrate 1 or the second substrate 4 may be applied to each magnetic particle 20 under the effect of an external magnetic field. In addition, when the magnetic material 22 is made of nickel which is electrically conductive, an insulation layer 23 may also enclose the outer surface of the magnetic layer 22, so as to prevent a wire on an array substrate from being short-circuited due to the existence of nickel.

The display device may be a display panel, and at this time, it may further include liquid crystals 3 arranged between the first substrate 1 and the second substrate 4. The first substrate 1 may be an array substrate or a color filter substrate. When the first substrate 1 is an array substrate, the second substrate 4 may be a color filter substrate, and when the first substrate 1 is a color filter substrate, the second substrate 4 may be an array substrate. A structure of each of the first substrate 1 and the second substrate 4 is known in the art and thus will not be particularly defined herein. FIG. 3 is a planar view of the display device.

According to the display device in the embodiments of the present disclosure, the plurality of magnetic particles 20 may be arranged in the sealant 2, and the magnetic layer 22 may enclose the outer surface of the supporting core 21 of each magnetic particle 20. When the external magnetic field is applied from one side of the first substrate 1 or the second substrate 4 toward the sealant 2, the magnetic field force pointing toward the first substrate 1 or the second substrate 4 may be applied to each magnetic particle 20, so as to increase a friction force between the magnetic particle and the first substrate 1 or the second substrate 4, thereby to weaken the flow of the sealant 2. As a result, it is able to prevent the sealant from being pierced through by the liquid crystals, prevent the liquid crystals from being polluted, and prevent the occurrence of after images, thereby to improve the display quality of the display device.

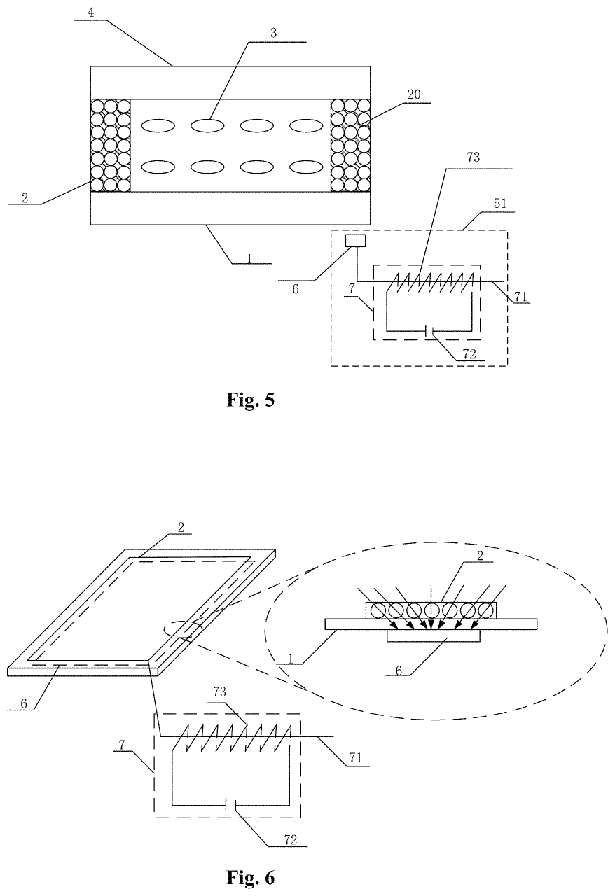

As shown in FIG. 5, in order to apply the magnetic field force pointing toward the first substrate 1 or the second substrate 4 to each magnetic particle 20 under the effect of the external magnetic field, the display device may further include a magnetic field generation unit 51 arranged at a side of the first substrate 1 and configured to generate a magnetic field pointing toward the first substrate 1 between the first substrate 1 and the second substrate 4. A position of the magnetic field may correspond to a position of the sealant. In a possible embodiment of the present disclosure, the magnetic field generation unit 51 may also be arranged at a side of the second substrate 4 and configured to generate the magnetic field pointing toward the second substrate 4 between the first substrate 1 and the second substrate 4. At this time, a position of the magnetic field may also correspond to a position of the sealant 2.

In the embodiments of the present disclosure, after the first substrate 1 is arranged opposite to the second substrate 4 to form a cell and before the sealant 2 is cured, the first substrate 1 and the second substrate 4 may be moved into the magnetic field generation unit 51. The magnetic field generation unit 51 may generate the magnetic field pointing toward the first substrate 1 or the second substrate 4 between the first substrate 1 and the second substrate 4 and the position of the magnetic field may correspond to the position of the sealant 4. At this time, the magnetic field force pointing toward the first substrate 1 or the second substrate 4 may be applied to each magnetic particle 20 in the sealant 2, so as to increase the friction force between the magnetic particle 20 and the first substrate 1 or the second substrate 4, thereby to weaken the flow of the sealant 2. As a result, it is able to prevent the sealant from being pierced through by the liquid crystals, prevent the liquid crystals from being polluted, and prevent the occurrence of after images, thereby to improve the display quality of the display device.

To be specific, as shown in FIGS. 5 and 6, the magnetic field generation unit 51 may include a conductive loop 6, and an electromagnetic conversion member 6 connected to the conductive loop 6 and configured to apply the magnetic field to the conductive loop 6. The conductive loop 6 may be arranged at a side of the first substrate 1 away from the second substrate 4, and extend along the sealant 2. In a possible embodiment of the present disclosure, the conductive loop 6 may be arranged at a side of the second substrate 4 away from the first substrate 1, and extend along the sealant 2.

Specifically, as shown in FIGS. 5 and 6, the electromagnetic conversion member may include a wire 71, a power source 72 and a coil 73. The wire 71 may be connected to the conductive loop 6. The coil 73 may be wound on the wire 71, with one end being connected to a positive pole of the power source 72 and the other end being connected to a negative pole of the power source 72.

Of course, apart from the coil, the magnetic field may be generated by the magnetic field generation unit in any other forms.

In a possible embodiment of the present disclosure, an orthogonal projection of the conductive loop 6 onto the first substrate may coincide with an orthogonal projection of the sealant 2 onto the first substrate, so that the magnetic field generated by the coil 73 along the conductive loop 6 is applied to the sealant 2 in a direction perpendicular to the first substrate 1 or the second substrate 4.

In order to apply the magnetic field force to each magnetic particle 20 in the sealant 2 in a more concentrated manner and further increase the friction force, a width of the conductive loop may be smaller than or equal to a width of the sealant 2 in a first direction (e.g., a horizontal direction of the first substrate 1).

In order to describe the embodiments of the present disclosure clearly, the display device will be described hereinafter in more details.

Here, the first substrate 1 may be an array substrate, the second substrate 4 may be a color filter substrate, and the magnetic field generation unit may be arranged at a side of the first substrate 1.

As shown in FIGS. 5 and 6, the sealant 2 may be applied to the first substrate 1 at a predetermined position. For example, the sealant 2 may be applied in such a manner as to form a rectangular shape. Of course, a shape of the sealant 2 may also be selected in accordance with the practical need. The magnetic field generation unit 51 may be arranged at a side of the first substrate 1 away from the second substrate 4. During the implementation, an orthogonal projection of the conductive loop 6 of the magnetic field generation unit 51 onto the first substrate may coincide with an orthogonal projection of the sealant 2 onto the first substrate. The wire 71 of the electromagnetic conversion member 7 may be connected to the conductive loop 6. The coil 73 may be wound onto the wire 71, with one end being connected to the positive pole of the power source 72 and the other end being connected to the negative pole of the power source 72. An intensity of the magnetic field generated by the electromagnetic conversion member 7 may be calculated through the following equation: H=NI/Le, where H represents the intensity of the magnetic field generated by the electromagnetic conversion member 7 and has a unit of ampere per meter (A/m), N represents the number of turns of the coil 73, I represents a current flowing through the coil 73 and has a unit of ampere (A), and L2 represents a valid magnetic path length of the conductive loop 6 and has a unit of meter (m). Through the electromagnetic conversion member 7, it is able to convert an electric field into the magnetic field.

After the first substrate 1 is arranged opposite to the second substrate 4 to form a cell and before the sealant 2 is cured with the ultraviolet light, as shown in FIGS. 5, 6 and 7, the power source 72 may be enabled, so as to apply a current to the coil 73 and enable the coil 73 to form an energized solenoid. The magnetic field may be generated by the energized coil 73 and transmitted to the conductive loop 6 via the wire 71, so as to generate the magnetic field above the conductive loop 6 and perpendicular to the first substrate 1. When the width of the conductive loop is smaller than the width of the sealant 2 in the first direction (e.g., the horizontal direction of the first substrate 1), the magnetic field force pointing toward the conductive loop 6 may be applied to each magnetic particle in the sealant 2 under the effect of the magnetic field (in FIG. 6, a direction of a magnetic field line is indicated by each arrow), so as to increase the friction force between the sealant 2 and the first substrate 1. After the sealant 2 has been cured, the first substrate 1 and the second substrate 2 may be moved out of the magnetic field generation unit.

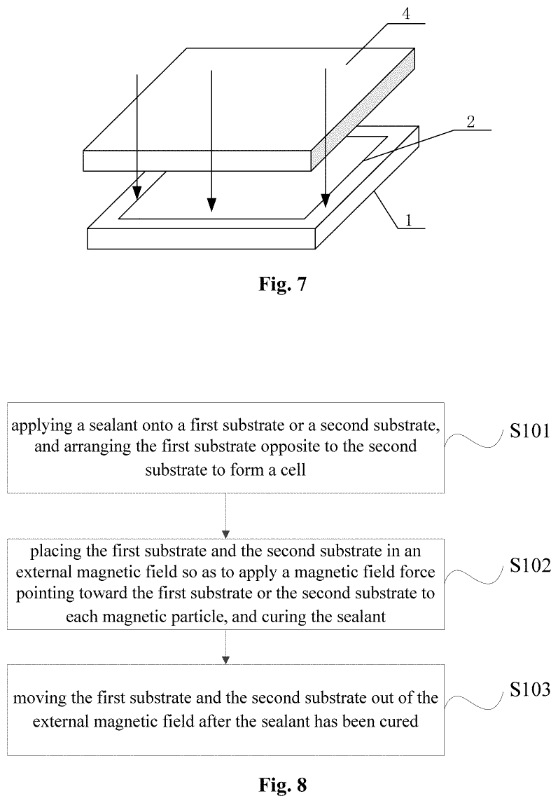

When the power source 72 is enabled, a downward magnetic field force may be applied to each magnetic particle 20 in the sealant 2, as shown in FIGS. 6 and 7 (a direction of a magnetic field line is indicated by each arrow), so as to increase the friction force between the magnetic particle 20 and the first substrate 1, thereby to further weaken the flow of the sealant 2. As a result, it is able to prevent the liquid crystals 3 from being mixed with the sealant 2, thereby to prevent the sealant from being pierced through by the liquid crystals.

As mentioned above, the magnetic field generated by the magnetic field generation unit may take effect during the curing of the sealant 2. However, the magnetic field may also be adopted to correct a position of the sealant 2 when the sealant 2 is applied at a wrong position. During the implementation, apart from the defects caused when the sealant 2 is pieced through by the liquid crystals, there may exist the other defects when the sealant 2 is applied at the wrong position. For example, when the sealant 2 is applied at the wrong position, a circuit of the display panel may be exposed to be outside, and thereby may easily be oxidized, corroded or etc. At this time, the position of the sealant 2 may be adjusted to a predetermined position under the effect of the magnetic field generated by the magnetic field generation unit on the magnetic particles 20.

The present disclosure further provides in some embodiments a sealant which includes a colloid and a plurality of magnetic particles 20 arranged in the colloid. Each magnetic particle 20 includes a supporting core 21 and a magnetic layer 22 enclosing an outer surface of the supporting core 21. FIG. 4 shows the structure of the magnetic particle 20.

When the sealant 2 is applied onto a substrate and a magnetic field is applied to the sealant 2, a magnetic field force pointing toward the substrate may be applied to each magnetic particle 20, so as to increase a friction force between the magnetic particle 20 and the substrate. As a result, it is able to weaken the flow of the sealant 2, thereby to locate the sealant at a desired position in a better manner.

In a possible embodiment of the present disclosure, as shown in FIG. 4, the sealant 2 may further include an insulation layer 23 enclosing the outer surface of the magnetic layer 22, so as to protect the supporting core 21 and the magnetic layer 22, and provide an insulation effect on electric signals.

Illustratively but non-restrictively, the supporting core 21 may be a silicon ball, and the magnetic layer 22 may be made of nickel or ferroferric oxide. The supporting core 21 may be arranged in a manner similar to that known in the art so as to support the first substrate and the second substrate, which will thus not be particularly defined herein.

A process for manufacturing the magnetic layer 22 and the insulation layer 23 will be described hereinafter in more details.

The magnetic layer 22 may be deposited as follows. Nanoscale magnetic metal particles (e.g., nickel (Ni) or ferroferric oxide (Fe₃O₄)) may be deposited onto the outer surface of the supporting core 21 through an electroless plating process. Here, the nanoscale Ni particles and the silicon ball will be taken as an example. At first, a solution mixed with silicon balls maybe prepared. Next, 10 ml of a 0.8 mol/L nickel chloride (NiCl₂) solution, 13.6 ml of absolute ethyl alcohol and 6.7 ml of distilled water may be added into the solution mixed with the silicon balls, and a resultant mixture may be stirred uniformly in a 100 ml beaker. Next, a temperature-constant magnetic stirrer capable of displaying readings may be placed into the beaker, and the mixture may be heated while being stirred. During the heating and stirring, a 5 mol/L NaOH solution may be added so as to adjust a pH value of the resultant mixture to about 14. After the adjustment of the pH value, about 20 ml of hydrazine hydrate may be added drop by drop, and a resultant mixture may be heated to 50° C. and maintain for about 0.5 h. Then, a resultant sample may be washed and dried at a temperature of 50° C. for 2 h in a vacuum oven, so as to acquire the silicon ball with a magnetic Ni layer being deposited onto its outer surface. The magnetic particles having different magnetic properties may be acquired through the adjustment of a concentration of the NiCl₂ solution.

In another embodiment, the insulation layer 23 may be deposited as follows. A matrix including the magnetic particles acquired as mentioned above may be subjected to ultrasonic dispersion in an ethanol solution, and added into a dopamine solution having a centration of 0.5 g/L to 4 g/L and a pH value of 6.0 to 10.0. Next, a resultant mixture may be stirred for 2 h to 48 h at a rate of 30 revolutions per minute (rpm) to 100 rpm, so that dopamine in the dopamine solution is capable of being deposited onto the outer surface of the magnetic layer 22, thereby to acquire the magnetic particle 20 as shown in FIG. 4.

The present disclosure further provides in some embodiments a method for manufacturing the above-mentioned display device which, as shown in FIG. 8, includes:

S101 of applying a sealant onto a first substrate or a second substrate, and arranging the first substrate opposite to the second substrate to form a cell;

S102 of placing the first substrate and the second substrate in an external magnetic field so as to apply a magnetic field force pointing toward the first substrate or the second substrate to each magnetic particle, and curing the sealant; and

S103 of moving the first substrate and the second substrate out of the external magnetic field after the sealant has been cured.

During the implementation, S101 of applying the sealant onto the first substrate or the second substrate and arranging the first substrate opposite to the second substrate to form a cell is similar to that known in the art, and thus will not be particularly defined herein.

In addition, S102 of curing the sealant is similar to that known in the art, and thus will not be particularly defined herein. In a word, conventional processes may be adopted for the application and the curing of the sealant, so the manufacture cost may not increase.

The present disclosure has the following beneficial effects.

Firstly, when the sealant is applied onto a substrate and a magnetic field is applied to the sealant, the magnetic field force pointing toward the substrate may be applied to each magnetic particle, so as to increase the friction force between the magnetic particle and the substrate. As a result, it is able to weaken the flow of the sealant, thereby to locate the sealant at a desired position in a better manner.

Secondly, the plurality of magnetic particles may be arranged in the sealant, and the magnetic layer may enclose the outer surface of the supporting core of each magnetic particle. When the external magnetic field is applied from one side of the first substrate 1 or the second substrate toward the sealant, the magnetic field force pointing toward the first substrate or the second substrate may be applied to each magnetic particle, so as to increase a friction force between the magnetic particle and the first substrate or the second substrate, thereby to weaken the flow of the sealant. As a result, it is able to prevent the sealant from being pierced through by the liquid crystals, prevent the liquid crystals from being polluted, and prevent the occurrence of after images, thereby to improve the display quality of the display device.

Thirdly, after the first substrate is arranged opposite to the second substrate to form a cell and before the sealant is cured, the first substrate and the second substrate may be moved into the external magnetic field, and the magnetic field force pointing toward the first substrate or the second substrate may be applied to each magnetic particle in the sealant, so as to increase the friction force between the magnetic particle and the first substrate or the second substrate, thereby to weaken the flow of the sealant. As a result, it is able to prevent the sealant from being pierced through by the liquid crystals, prevent the liquid crystals from being polluted, and prevent the occurrence of after images, thereby to improve the display quality of the display device.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

What is claimed is:

1. A display device, comprising
a first substrate, a second substrate arranged opposite to the first substrate, and
a sealant configured to seal the first substrate and the second substrate, wherein
the sealant comprises a colloid and a plurality of magnetic particles arranged in the colloid, each magnetic particle comprises a supporting core and a magnetic layer enclosing an outer surface of the supporting core, and a magnetic field force pointing toward the first substrate or the second substrate is applied to each magnetic particle under an effect of an external magnetic field.

2. The display device according to claim 1, further comprising a magnetic field generation unit configured to generate a magnetic field pointing toward the first substrate between the first substrate and the second substrate, wherein a position of a region of the magnetic field corresponds to a position of the sealant.

3. The display device according to claim 2, wherein the magnetic field generation unit comprises a conductive loop, and an electromagnetic conversion member connected to the conductive loop to generate the magnetic field for the conductive loop, wherein the conductive loop is arranged along with the sealant.

4. The display device according to claim 3, wherein the conductive loop is arranged at a side of the first substrate away from the second substrate.

5. The display device according to claim 3, wherein the conductive loop is arranged at a side of the second substrate away from the first substrate.

6. The display device according to claim 3, wherein the electromagnetic conversion member comprises a wire, a power source and a coil, the wire is connected to the conductive loop, and the coil is wound onto the wire with one end being connected to a positive pole of the power source and the other end being connected to a negative pole of the power source.

7. The display device according to claim 3, wherein an orthogonal projection of the conductive loop onto the first substrate coincides with an orthogonal projection of the sealant onto the first substrate.

8. The display device according to claim 3, wherein a width of the conductive loop is smaller than or equal to a width of the sealant in a first direction.

9. The display device according to claim 1, wherein the sealant further comprises an insulation layer enclosing an outer surface of the magnetic layer.

10. A sealant, comprising a colloid and a plurality of magnetic particles arranged in the colloid, wherein each magnetic particle comprises a supporting core and a magnetic layer enclosing an outer surface of the supporting core.

11. The sealant according to claim 10, further comprising an insulation layer enclosing an outer surface of the magnetic layer, wherein the supporting core is a silicon ball, and the magnetic layer is made of nickel or ferroferric oxide.

12. A method for manufacturing the display device according to claim 1, comprising:
applying a sealant onto a first substrate or a second substrate, and arranging the first substrate opposite to the second substrate to form a cell;
placing the first substrate and the second substrate in an external magnetic field to apply a magnetic field force pointing toward the first substrate or the second substrate to each magnetic particle, and curing the sealant; and
moving the first substrate and the second substrate out of the external magnetic field after the sealant has been cured.
